(19) United States
(12) Patent Application Publication
(10) Pub. No.: US 2006/0150919 A1
(43) Pub. Date: Jul. 13, 2006

(54) Animal chew toy

(76) Inventor: Daniel A. Thomason, Henderson, KY (US)

Correspondence Address: C RICHARD MARTIN;MARTIN & MARTIN, PO BOX 29, BOONVILLE, IN, 47601, US

(21) Appl. No.: 11/031,914

(22) Filed: Jan. 7, 2005

(51) Int. Cl. A01K 29/00

(52) U.S. Cl. 119/710

(57) ABSTRACT

The invention provides a synthetic chew toy formed of a unitary and rigid frame having an elongated center region, a base member at a first end and a chew portion at a second end thereof. The base member includes two opposing outwardly extending flanges. A channel may be formed in a surface of the frame in the elongated center region to permit flavorful foods such as peanut butter therein. A plurality of bulbous projections, such as those on the end of a bone, are formed on and extend from the chew portion of the chew toy. The frame is preferably comprised of nylon infused with fluoride, flavor and/or scent.

### BACKGROUND OF THE INVENTION

The invention relates generally to chew toys for dogs and more particularly to a chew toy having a therapeutic effect on a dog's teeth and gums.

Various products exist in the market which are intended to clean a pet's teeth as the pet chews the product or to satisfy a pet's chewing urge. One type of product is an edible chew toy, made of materials such as rawhide, which is extremely hard and therefore unacceptable for certain older dogs or dogs with tooth problems. Such products also present health hazzards to pets ingesting the rawhide material, sometimes requiring expensive emergency surgery. Other chew toys are formed of soft rubber materials and can exhibit unsatisfactorily high flexibility and/or unsatisfactory low durability. Other plastic products are molded from hard materials and can expose the inside of a dogs mouth to undesirably hard or sharp product. Similarly, natural bone also can splinter into hard sharp objects which can be dangerous and harmful.

Accordingly, it is desirable to provide a synthetic chew toy for a pet, such as a dog, which overcomes shortcomings of existing chew toys.

### SUMMARY OF THE INVENTION

Generally speaking, in accordance with the invention, a synthetic chew toy formed of a unitary and rigid frame having an elongated center region, a base member at a first end and a chew portion at a second end thereof. The base member includes an outwardly extending flange, a plurality of outwardly extending flanges, or according to one preferred embodiment, two opposing outwardly extending flanges. The chew toy may further include gripping means on an upper surface of each of said flanges. A channel may be formed in a surface of the frame in the elongated center region to permit flavorful foods such as peanut butter therein. A plurality of bulbous projections, such as those on the end of a bone, are formed on and extend from the chew portion. The frame is preferably comprised of nylon infused with fluoride, flavor and/or scent.

Accordingly, it is an object of the invention to provide an improved chew toy for pets, such as dogs.

Another object of the invention is to provide a chew toy for pets, having high durability that won't splinter or come apart like rawhide or natural bones.

Yet another object of the invention is to provide a chew toy for pets, that promotes healthy teeth and gums.

Still other objects and advantages of the invention will in part be obvious and will in part be apparent from the specification and drawings.

The invention accordingly comprises the several steps and the relation of one or more of such steps with respect to each of the others, and the article possessing the features, properties, and the relation of elements, which are exemplified in the following detailed disclosure, and the scope of the invention will be indicated in the claims.

### BRIEF DESCRIPTION OF THE DRAWINGS

FIG. 1 shows a side elevation view of an animal chew toy according to a preferred embodiment of the present invention.

### DETAILED DESCRIPTION OF PREFERRED EMBODIMENTS

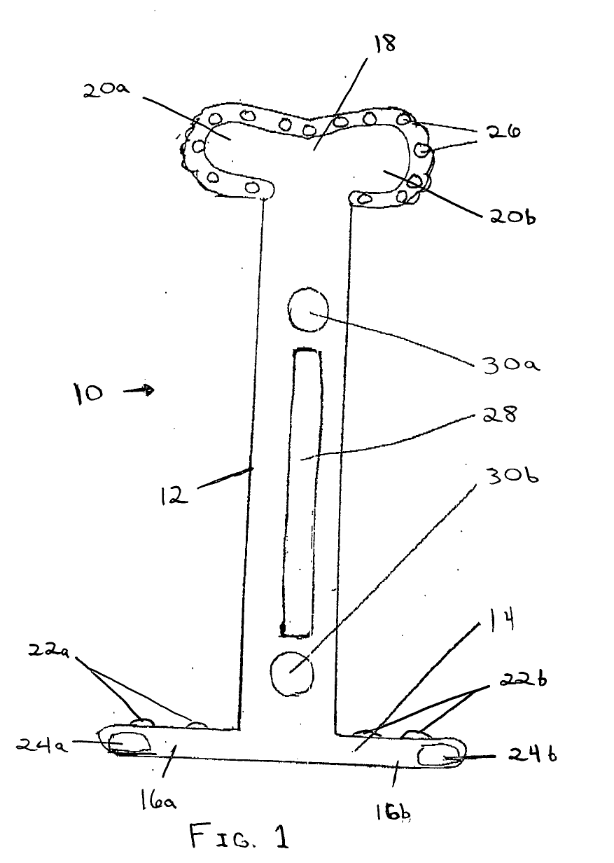

Referring now to FIG. 1 there is shown an animal chew toy 10 according to a preferred embodiment of the present invention. Chew toy 10 is comprised of a unitary and rigid frame having an elongated center region 12. At a first end of the elongated center region 12 is a base member 14 having a pair of opposing outwardly extending flanges 16a, 16b which form a stand-up base for the chew toy 10. At a second end of the elongated center region 12 is a chew portion 18 of the chew toy 10. The chew portion 18 of the chew toy 10 includes a pair of bulbous projections 20a, 20b in the general shape of a bone end.

Longitudinally extending projections 22a, 22b extend outwardly from upper surfaces of the flanges 16a, 16b, respectively, to aid the animal in gripping the chew toy 10 with its paws. Support flanges 24a, 24b are also provided on the sides of the primary flanges 16a, 16b to further aid the animal in holding the chew toy 10 in an upright position. The support flanges 24a, 24b are preferably provided on both opposing sides of the primary flanges 16a, 16b.

The outer perimeter of the bulbous projections 20a, 20b preferably include a plurality of outwardly projecting cleaning nubs 26, configured to help remove tartar and plaque from the animal's teeth and gums. One or more channels 28 and/or recessed holes 30 may also be formed in opposing surfaces of the elongated center region 12. The channels 28 and holes 30 are configured to receive soft foods, such as peanut butter or cream cheese to boost the animal's interest in the chew toy 10.

The chew toy 10 is preferably comprised of a material that is inert, rigid and resistant to splintering or breaking. According to one preferred embodiment, the chew toy frame 10 is formed primarily of nylon. To promote the animal's dental health, the nylon of the chew toy may be infused with fluoride. To promote interest, the nylon of the chew toy 10 may be infused with flavor and/or scent. According to a preferred embodiment, the chew toy frame 10 comprises 99% nylon and 1% mixture comprising fluoride and flavor/scent. One embodiment found to be effective includes a chew toy formed of 99% nylon and 1% fluoride/flavor/scent mixture having between 1 parts per million (ppm) and 2 ppm fluoride. However, the percentages of flavor/scent and fluoride may be adjusted for maximum flavor and fluoride effectiveness.

Although the present invention has been illustrated and described herein with respect to certain preferred embodiments, it is not intended that this patent should be limited in scope and coverage by such details other than as specifically set forth in the following claims.

I claim:

1. An animal chew toy comprising:
a unitary and rigid frame, said frame having an elongated center region, a base member at a first end of said elongated center region, and a chew portion at a second end of said elongated center region, wherein said base member includes an outwardly extending flange.

2. The animal chew toy of claim 1, wherein said base member includes a plurality of outwardly extending flanges.

3. The animal chew toy of claim 1, wherein said base member includes two opposing outwardly extending flanges.

4. The animal chew toy of claim 3, further including gripping means on an upper surface of each of said flanges.

5. The animal chew toy of claim 1, further comprising a channel formed in a surface of the frame in the elongated center region.

6. The animal chew toy of claim 1, further comprising a plurality of bulbous projections formed on and extending from the chew portion.

7. The animal chew toy of claim 1, wherein the frame comprises nylon.

8. The animal chew toy of claim 7, wherein said nylon is infused with fluoride.

9. The animal chew toy of claim 8, wherein said nylon is infused with scent and flavor.

10. The animal chew toy of claim 7, wherein said nylon is infused with scent and flavor.

11. The animal chew toy of claim 1, wherein the frame comprises 99% nylon, 0.9% scent/flavor additive, and 0.1% fluoride.

12. An animal chew toy comprising:
a unitary and rigid nylon frame, said frame having an elongated center region, a base member at a first end of said elongated center region, and a chew portion at a second end of said elongated center region, wherein said nylon is infused with fluoride.

13. The animal chew toy of claim 12, wherein said base member includes two opposing outwardly extending flanges.

14. The animal chew toy of claim 13, further including gripping means on an upper surface of each of said flanges.

15. The animal chew toy of claim 12, further comprising a channel formed in a surface of the frame in the elongated center region.

16. The animal chew toy of claim 12, further comprising a plurality of bulbous projections formed on and extending from the chew portion.

17. An animal chew toy comprising:
a unitary and rigid nylon frame, said frame having an elongated center region, a base member at a first end of said elongated center region, and a chew portion at a second end of said elongated center region, and a channel formed in a surface of the frame in the elongated center region.

18. The animal chew toy of claim 17, wherein said base member includes two opposing outwardly extending flanges.

19. The animal chew toy of claim 17, further comprising a plurality of bulbous projections formed on and extending from the chew portion.

20. The animal chew toy of claim 17, wherein said nylon is infused with fluoride and flavor.
